(19) United States
(12) Patent Application Publication
(10) Pub. No.: US 2026/0064243 A1
(43) Pub. Date: Mar. 5, 2026

(54) METHOD FOR INPUTTING SCHEDULE BY USING QUICK BUTTON

(71) Applicant: C.G.TAE TECHNOLOGY INC., Seongnam-si (KR)

(72) Inventors: Chul Gyu TAE, Seongnam-si (KR); Choe TAE, Seongnam-si (KR)

(21) Appl. No.: 19/101,156

(22) PCT Filed: Aug. 3, 2023
(86) PCT No.: PCT/KR2023/011422

§ 371 Date: Jul. 1, 2025

(30) Foreign Application Priority Data
Aug. 5, 2022 (KR) 10-2022-0097785

(51) Int. Cl. G06F 3/0482; G06Q 10/109

(52) U.S. Cl. CPC G06F 3/0482; G06Q 10/1097

(57) ABSTRACT

A method of inputting a schedule using quick buttons, comprises: providing, in a user interface of an application, a time input section for entering a time for a schedule; providing, in the user interface, one or more selectable quick buttons for the schedule, wherein each of the one or more quick buttons includes a thumbnail that visually represents the content of the schedule, and the schedule includes at least one of a repetitive schedule and a user-set schedule; receiving a selection of one of the one or more quick buttons and an input of the time for the schedule; displaying, in the user interface, one or more selectable detailed item buttons associated with the schedule of the selected quick button, wherein each of the one or more detailed item buttons includes a thumbnail that visually represents the content of the detailed item; and receiving a selection of one of the one or more detailed item buttons.

### TECHNICAL FIELD

The present disclosure relates to a method of inputting schedules using a quick button, and more specifically, to a method that allows a user of a calendar application to easily and promptly input repetitive or routine schedules through a quick button.

### BACKGROUND ART

The use of calendar applications on various user devices, such as personal computers (PCs), laptops, tablets, mobile phones, and wearable devices, has become widespread. These calendar applications initially only had functions, such as simply displaying a calendar and allowing users to input simple schedules. However, they have gradually evolved to include various features that enhance the user experience. However, the majority of users of conventional calendar applications often do not fully utilize or are unable to utilize most of the various features offered. In most cases, they use calendar applications merely for sporadically recording a few schedules and setting reminders.

### SUMMARY OF INVENTION

### Technical Problem

Accordingly, an object of the present disclosure is to enable a user of a calendar application to easily and promptly add repetitive or routine schedules, thereby increasing the utilization of the calendar application and allowing continuous creation of daily schedules.

However, the problems to be solved by the present disclosure are not limited to those mentioned above. The objects not explicitly mentioned but clearly understood by those skilled in the art to which the present disclosure pertains, based on the following description, are also included within the scope of the present disclosure.

### Solution to Problem

According to some aspects of the disclosure, a method of inputting a schedule using quick buttons, comprises: providing, in a user interface of an application, a time input section for entering a time for a schedule; providing, in the user interface, one or more selectable quick buttons for the schedule, wherein each of the one or more quick buttons includes a thumbnail that visually represents the content of the schedule, and the schedule includes at least one of a repetitive schedule and a user-set schedule, receiving a selection of one of the one or more quick buttons and an input of the time for the schedule; displaying, in the user interface, one or more selectable detailed item buttons associated with the schedule of the selected quick button, wherein each of the one or more detailed item buttons includes a thumbnail that visually represents the content of the detailed item; and receiving a selection of one of the one or more detailed item buttons.

According to some aspects, the schedule selectable through the quick button includes at least one of a schedule related to meals, a schedule related to rest, a schedule related to move, and a schedule related to entertainment.

According to some aspects, when a schedule related to meals is selected through the quick button, one or more detailed item buttons associated with the selected quick button include a plurality of meal type buttons.

According to some aspects, when a schedule related to rest is selected through the quick button, one or more detailed item buttons associated with the selected quick button include a plurality of rest type buttons.

According to some aspects, the user interface includes an input panel, and the one or more quick buttons and the time input section are provided on the input panel.

According to some aspects, the user interface includes an input panel, and the one or more detailed item buttons are displayed in an item display section included in the input panel.

According to some aspects, the method further comprises: displaying a changed name of at least one component of the input panel in response to the receiving a selection of one of the one or more quick buttons.

According to some aspects, the input panel includes a first time input section for entering a time for a first time range and a second time input section for entering a time for a second time range following the first time range, and wherein some of the one or more quick buttons are displayed adjacent to the first time input section, and the remaining quick buttons of the one or more quick buttons are displayed adjacent to the second time input section.

According to some aspects, the input panel further includes an item display section, wherein some of the one or more quick buttons displayed adjacent to the first time input section include an extended quick button, and wherein the method further comprises: receiving a selection of the extended quick button; and in response to the receiving the selection of the extended quick button, displaying the remaining quick buttons among the one or more quick buttons displayed adjacent to the second time input section in the item display section of the input panel.

According to some aspects, the method further comprises: receiving a selection of a registration button for registering the schedule; and in response to the selection of the registration button, generating a schedule item in at least one of a timeline and a schedule display table of the user interface.

According to some aspects, the generated schedule item includes the name of the selected quick button.

According to some aspects of the disclosure, an apparatus for implementing a schedule input method using quick buttons, the apparatus comprises: a processor, and a memory including computer-executable instructions, wherein the computer-executable instructions, when executed by the processor, cause the processor to perform operations including: providing, in a user interface of an application, a time input section for entering a time for a schedule, providing, in the user interface, one or more selectable quick buttons for the schedule, wherein each of the one or more quick buttons includes a thumbnail that visually represents the content of the corresponding schedule, and the corresponding schedule includes at least one of a repetitive schedule and a user-set schedule; receiving a selection of one of the one or more quick buttons and an input of the time for the schedule; displaying, in the user interface, one or more selectable detailed item buttons associated with the schedule of the selected quick button, wherein each of the one or more detailed item buttons includes a thumbnail that visually represents the content of the corresponding detailed item; and receiving a selection of one of the one or more detailed item buttons.

According to some aspects of the disclosure, a computer-readable recording medium storing computer-executable instructions, wherein the computer-executable instructions, when executed by a processor, cause the processor to perform operations including: providing, in a user interface of an application, a time input section for entering a time for a schedule; providing, in the user interface, one or more selectable quick buttons for the schedule, wherein each of the one or more quick buttons includes a thumbnail that visually represents the content of the corresponding schedule, and the corresponding schedule includes at least one of a repetitive schedule and a user-set schedule; receiving a selection of one of the one or more quick buttons and an input of the time for the schedule; displaying, in the user interface, one or more selectable detailed item buttons associated with the schedule of the selected quick button, wherein each of the one or more detailed item buttons includes a thumbnail that visually represents the content of the corresponding detailed item; and receiving a selection of one of the one or more detailed item buttons.

### Advantageous Effects

The calendar application according to embodiments of the present disclosure has a remarkable effect in that, by introducing a quick button, a user may promptly add repetitive or routine schedules and/or user-set schedules through a simple and intuitive selection process of two to three steps, without the need for separate category input. Furthermore, the introduction of such a quick button has the effect of enabling a user to continuously (or substantially without gaps) create their daily schedule, i.e., a timeline.

However, the effects achievable by the present disclosure are not limited to those mentioned above. Other effects not explicitly mentioned may also be clearly understood by those skilled in the art to which the present disclosure pertains based on the following description.

### BRIEF DESCRIPTION OF THE DRAWINGS

The following drawings attached to the present specification illustrate preferred embodiments of the present disclosure and serve to further aid in understanding the technical spirit of the present disclosure in conjunction with the detailed description. Therefore, the present disclosure should not be construed as being limited only to the matters described in such drawings.

FIGS. 1a and 1b are diagrams illustrating examples of a system for using a calendar application according to an embodiment of the present disclosure.

FIG. 2 is an exemplary diagram illustrating the main screen of the user interface for the calendar application according to an embodiment of the present disclosure.

FIGS. 3 and 4 are exemplary screens illustrating the main window of the user interface for the calendar application according to an embodiment of the present disclosure when scrolled upward and downward, respectively.

FIGS. 5a and 5b are exemplary diagrams illustrating the basic form and the expanded form of the timeline for dates other than today in the user interface of the calendar application according to an embodiment of the present disclosure.

FIG. 6a is a diagram illustrating the input panel 220 according to an embodiment of the present disclosure.

FIG. 6b is an exemplary diagram illustrating a method for entering time through the time input section 221 according to an embodiment of the present disclosure.

FIG. 7 is a diagram illustrating an example of adding other users related to a schedule through the input panel according to an embodiment of the present disclosure.

FIG. 8 is a diagram illustrating a user interface in which counterparts for a schedule and attached files have been added according to an embodiment of the present disclosure.

FIGS. 9a and 9b are diagrams illustrating exemplary usage methods of the quick buttons in the input panel of the user interface of the calendar application according to an embodiment of the present disclosure.

FIGS. 10a, 10b, 10c, and 10d are diagrams illustrating a method of creating a schedule using quick buttons according to an embodiment of the present disclosure.

FIG. 11 is a flowchart illustrating a method of inputting a schedule using quick buttons according to an embodiment of the present disclosure.

### DETAILED DESCRIPTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

### System for Using a Calendar Application

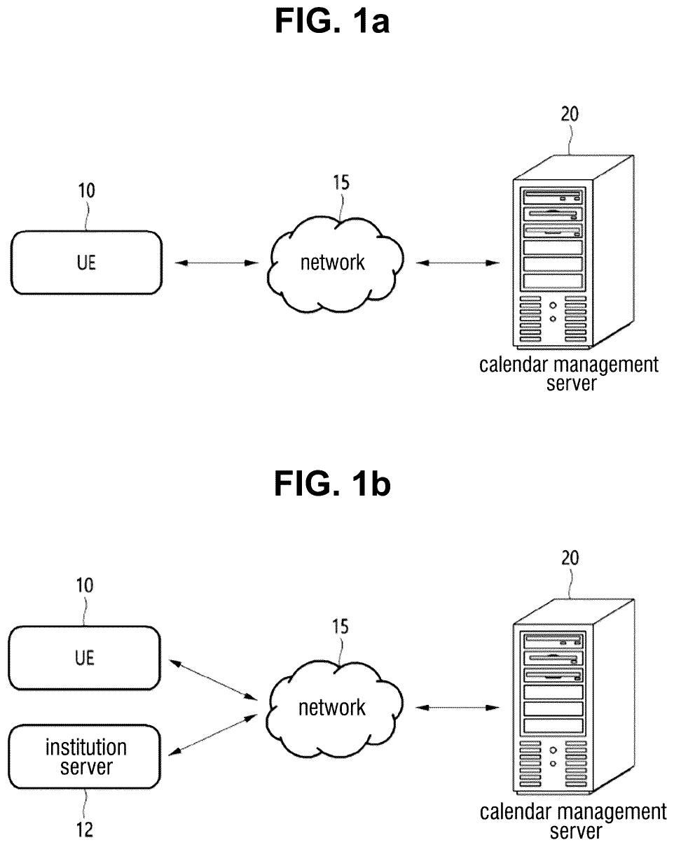

FIGS. 1a and 1b are diagrams illustrating examples of a system for using a calendar application according to an embodiment of the present disclosure.

Referring to the system shown in FIG. 1a, a user device 10 may be connected to a calendar management server 20 via a network 15. According to embodiments of the present disclosure, the calendar application may be installed on the user device 10 or may be used by utilizing calendar application-related resources of the calendar management server 20 in the form of a cloud through the user device 10. Additionally, the calendar application may be distributed across the user device 10 and the calendar management server 20.

The user device 10 may be any device equipped with a display capable of displaying the calendar application, such as a personal computer (PC), laptop, tablet, mobile phone, or wearable device, and may connect to the calendar management server via a network. The same user may use two or more user devices. In this case, the calendar application may operate in synchronization across the user's devices, or it may operate on only one user device at a time. The present disclosure does not limit the implementation method in this regard.

The network 15 may be a wired or wireless network. The user device 10 may connect to the network 15 through a wired LAN cable, through wireless internet such as Wi-Fi, 3G/4G/5G data networks at locations equipped with wireless access points (APs), or by transmitting and receiving wireless signals with peripheral devices to connect to the network 15. The specific method of connection is not limited.

The calendar management server 20 may be a server for providing, servicing, and managing the calendar application. As an example, the calendar management server 20 may provide services and updates for the calendar application, collect various data related to the calendar application, and generate and provide statistical information. The calendar management server 20 may provide the calendar application in the form of a cloud service or deliver calendar-related services through communication with the calendar application installed on the user device 10. The specific operational methods are not limited.

Referring to the system shown in FIG. 1b, the user device 10 and the institution server 12 may be connected to a calendar management server 20 via a network 15. The institution server 12, for example, may be a server operated by various institutions such as companies, schools, public institutions, or research institutes, and the user device 10 may be a personal device belonging to an individual affiliated with such an institution. In this case, the user device 10 may use the calendar application provided through the institution server 12 or, similar to the example in FIG. 1a, use the calendar application installed on the user device 10 itself or by utilizing the resources of the calendar management server 20.

However, unlike the examples in FIGS. 1a and 1b, the calendar application may be used solely on the user device, or it may operate in the form of an intranet only between the institution server and the user device without being connected to the calendar management server 20. The specific implementation methods are not limited.

In the example of the system in FIG. 1a and the example of the system in FIG. 1b, the user device 10 connects to the calendar management server 20 via the network 15, and the schedule data generated by the user utilizing the calendar application on the user device 10 may be collected by at least one of the calendar management server 20 or the institution server 12. For such schedule data to be collected and meaningful statistical data to be generated, the utilization of the calendar application must be enhanced. To achieve this, users need to be provided with motivation to actively use the calendar application. The calendar application and its user interface according to an embodiment of the present disclosure include various elements that enable users to gain positive experiences, such as improved work efficiency and prompt work feedback, through the use of the calendar application. These elements will be described in detail later. Meanwhile, in this regards, there may be issues related to privacy concerns, however, the present disclosure focuses solely on the technical aspects, irrespective of such issues.

### Configuration of the Main Screen of the User Interface for the Calendar Application

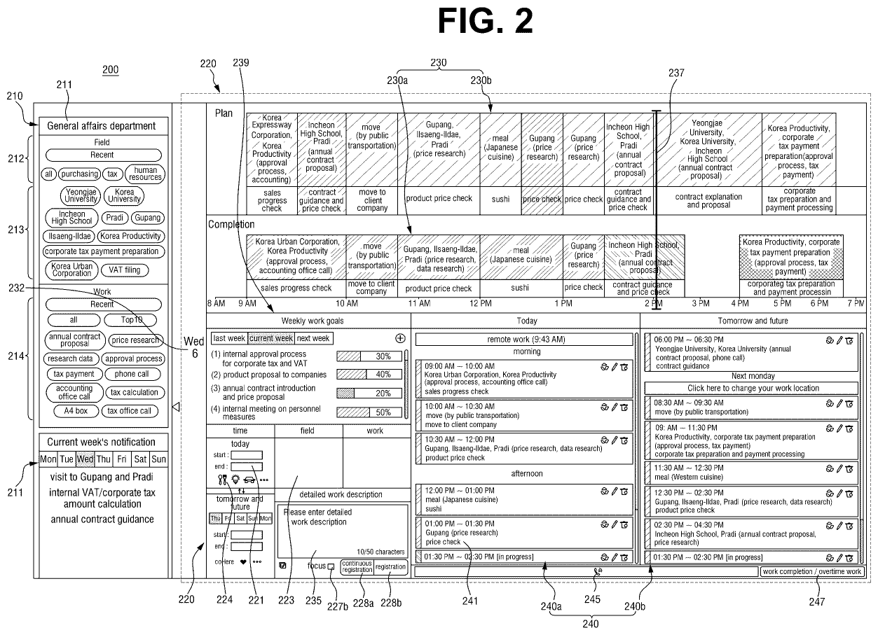

FIG. 2 is an exemplary diagram illustrating the main screen of the user interface for the calendar application according to an embodiment of the present disclosure.

In the user interface of the calendar application according to an embodiment of the present disclosure, the term “main screen” refers to the screen presented to the user upon first logging into the calendar application. However, the term “main screen” is used merely for convenience of explanation, and the user may customize the initial screen settings of the calendar application, the configuration may vary depending on the display size of the user device, or the layout of the initial screen may change according to updates to the calendar application. Therefore, the configuration of the main screen described below is merely exemplary.

Additionally, for convenience of explanation, this specification describes “a first time range” as referring to today, “a second time range” as referring to tomorrow and the future (dates after tomorrow), and “a third time range” as referring to the past (yesterday and dates before yesterday). However, the first to third time ranges may each be defined as different time ranges, and they are not limited thereto.

Referring to FIG. 2, the main screen 200 of the user interface for the calendar application may include: a category selection window 210 that allows for the selection and input of one or more categories of schedules; an input panel 220 for entering the time, category, and detailed work description for schedules of today (i.e., the first time range) or tomorrow and the future (i.e., the second time range); a timeline 230 that displays in chronological order the planned schedules the user intends to carry out today and the completed schedules actually carried out; and a schedule display table 240 that displays the schedules for today and for tomorrow and the future in the form of separate tables.

The category selection window 210 allows the user to select and input one or more categories related to the schedule, such as four categories. Among these four categories, the first category 211 may be the highest-level category, and for example, could be the “Department” category. The second category 212 may be the next-level category, which, for example, may classify “Fields” or “Teams.” The third category 213 may be a lower category of the second category 212 and may classify “Projects,” while the fourth category 214 may be a lower category of the third category 213 and may classify “Works.” However, the detailed configuration of each category in the category selection window 210 may be changed depending on the organization to which the user belongs or the user's preferences, and is not limited thereto.

At least some of the first to fourth categories 211, 212, 213, and 214 in the category selection window 210 may be selected by default, considering schedules recently performed by the user, all schedules, and so on. This is designed to minimize the need for the user to input all four categories individually. As a result, by introducing the category selection window 210 according to an embodiment of the present disclosure, an effect is achieved in which the user can input categories with minimal input without feeling burdened. In addition, from the perspective of the organization to which the user belongs, there is an effect of enabling the organization to easily grasp overall work efficiency and improvement direction by collecting the categorized schedules of individual users or employees.

The input panel 220 is an interface that allows the user to input time, category, and detailed work description for schedules for today (i.e., the first time range) or tomorrow and the future (i.e., the second time range). The schedules entered through the input panel 220 may either be newly registered schedules that will be created in the timeline 230 and the schedule display table 240, or schedules selected for editing from among those already displayed in the timeline 230 and the schedule display table 240. The specific usage method of the input panel 220 will be described in detail later.

The timeline 230 may include a completed timeline 230a that displays schedule boxes 231a for one or more completed schedules of the user for today in chronological order from left to right, and a planned timeline 230b that displays schedule boxes 231b for one or more planned schedules of the user for today in chronological order from left to right. Each schedule box 231a or 231b may be input and created by the user through the input panel 220.

The schedule display table 240 may include a first schedule display table 240a for displaying today's schedules in chronological order from top to bottom, and a second schedule display table 240b for displaying tomorrow's and future schedules in chronological order from top to bottom. The first schedule display table 240a and the second schedule display table 240b each include one or more schedule items 241, and each schedule item 241 may be input and created by the user through the input panel 220.

Additionally, the main screen 200 may further include: a goal display section 239 for graphically displaying the progress of work goals; a call history check button 245 that allows the user to save and view key call records; a work completion button 247 that enables the user to select between leaving work or working overtime; and a date display section 232 that displays schedule-related dates, work locations, and other schedule-related information. Additionally, below the category selection window 210, there may be a current week notification display section 211 that provides information on the planned schedules for the current week and a personal notepad (not shown).

As seen in the example of FIG. 2, the main screen 200 may include a category selection window 210 located in the left area of the main screen 200 and a main window 215 located to the right of the category selection window 210. Additionally, the timeline 230 may be located in the upper area of the main window 215, with the goal display section 239 and the input panel 220 positioned in the lower left section of the timeline 230, and the schedule display table 240 positioned in the center and lower right section of the timeline 230.

In the user interface of the calendar application according to an embodiment of the present disclosure, by placing the category selection window 210, which allows for schedule input, in the left section of the main screen 200, and the input panel 220 in the lower central section, the user is enabled to perform schedule input intuitively and easily. Additionally, by arranging schedules in two formats, namely a timeline and a table, respectively in the upper section and the lower right section of the main screen 200, the user is enabled to intuitively and easily check and manage their schedules.

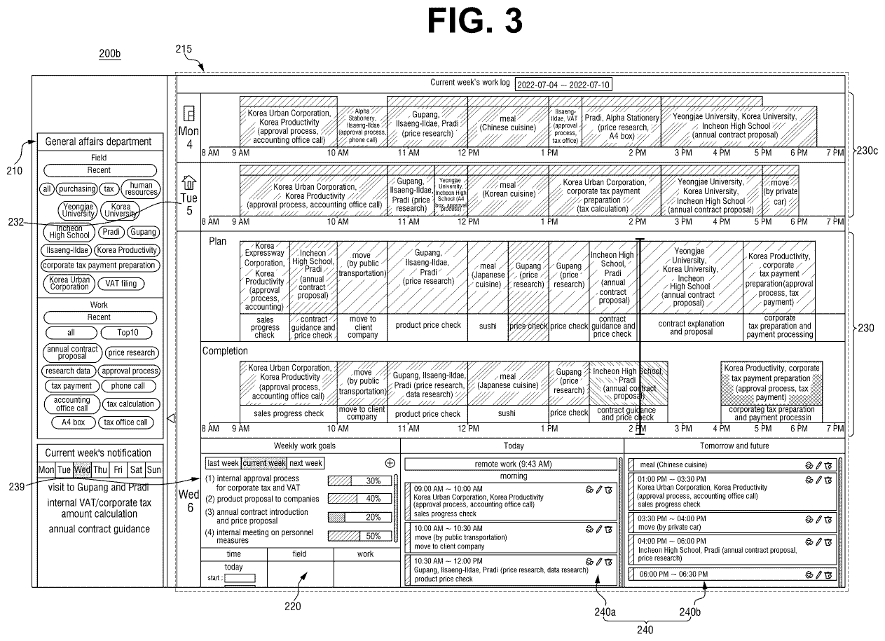

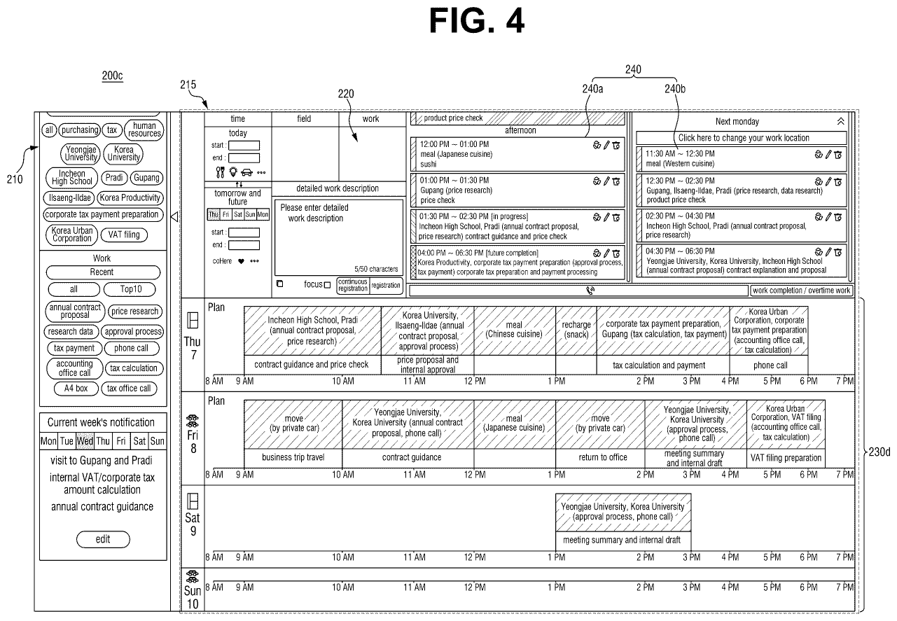

FIGS. 3 and 4 are exemplary screens illustrating the main window of the user interface for the calendar application according to an embodiment of the present disclosure when scrolled upward and downward, respectively. Referring to FIGS. 3 and 4, the main window 215 of the user interface for the calendar application according to an embodiment of the present disclosure is scrollable in the vertical direction.

First, referring to FIG. 3, in an exemplary screen 200b where the main window 215 is scrolled upward by manipulating the scrollbar or similar elements on the right side of the main window 215, one or more past timelines 230c, which display the schedules of yesterday (e.g., Tuesday) and the day before yesterday (e.g., Monday) in chronological order, may be displayed on the timeline 230 that chronologically shows today's (e.g., Wednesday's) schedules.

According to an embodiment of the present disclosure, the date range for the current week (e.g., “Current Week's Work Log 2002 Jul. 4˜2022 Jul. 10”) is displayed at the top of the main window 215, and only the timelines for the displayed current week, i.e., the schedule for a one-week period (Monday to Sunday of the week), may be viewed by scrolling. In the example of FIG. 3, today is Wednesday, and the past timeline 230c is shown to include two timelines corresponding to Tuesday and Monday. However, the number of past timelines 230c may vary depending on which day of the week today is.

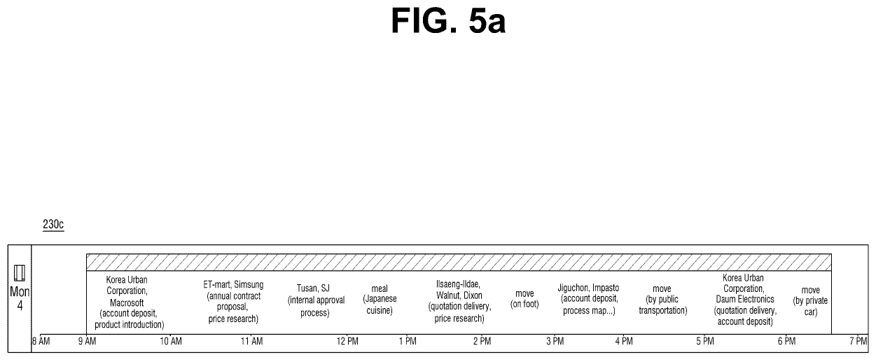

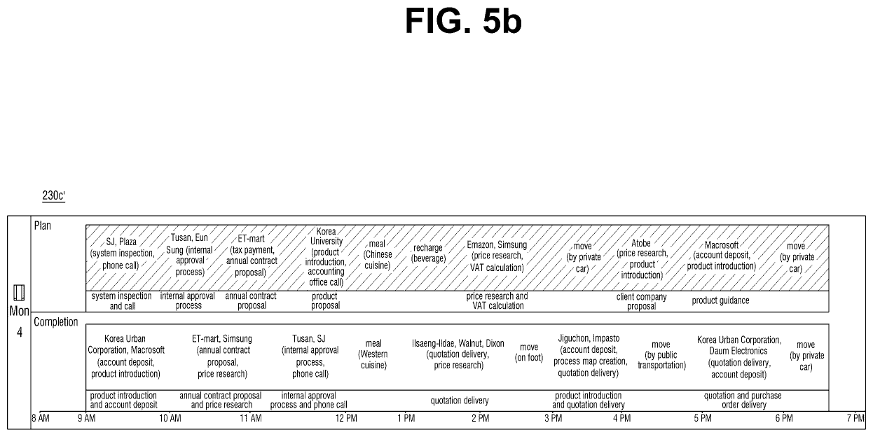

According to an embodiment, the past timeline 230c pertains to schedules prior to today (past) and may include both the timelines for planned schedules the user had set in the past and the timelines for completed schedules the user actually performed. For efficient use of display space, the planned schedules and completed schedules may each be displayed in a collapsed form. This will be described in detail later with reference to FIG. 5a and FIG. 5b.

Referring to FIG. 4, in an exemplary screen 200c where the main window 215 is scrolled downward by manipulating the scrollbar or similar elements on the right side of the main window 215, one or more future timelines 230d, which display the schedules for tomorrow and the future in chronological order by date, may be displayed below the input panel 220 and the schedule display table 240. In the example of FIG. 4, since today is Wednesday, four future timelines 230d corresponding to Thursday through Sunday of the current week are displayed. Since the future timeline 230d pertains to the future, it does not include completed schedules and may only contain planned schedules.

FIGS. 5a and 5b are exemplary diagrams illustrating the basic form and the expanded form of the timeline for dates other than today in the user interface of the calendar application according to an embodiment of the present disclosure.

Referring to FIG. 5a, the past timeline 230c for dates prior to today, in the basic (default) form, may display the planned schedules in a thin format where only the time slots of the schedules are visible, while the completed schedules may be displayed in a state where only the category information of the schedules is visible, with the detailed work descriptions omitted. Overall, it may take the form where the simplified timeline for planned schedules is displayed in a thin format on the simplified timeline for completed schedules, and in this case, the planned schedules and completed schedules may be distinguished by different colors. Displaying past timeline 230c in a simplified form (i.e., a basic form) as described above is intended to efficiently utilize the display space of the main screen and main window. This approach is based on the observation that, in practice, users rarely refer to timelines for dates other than the timeline related to today's schedule.

Referring to FIG. 5b, when the user selects or hovers over any position on the past timeline 230c using an input such as a mouse or touch, the past timeline 230c may transform into an expanded timeline 230c′. In the case of the expanded past timeline 230c′, similar to the timeline 230 for today's date (refer to FIGS. 2 and 3), it may include two timelines: a planned timeline for planned schedules and a completed timeline for completed schedules. The planned schedules and completed schedules may be displayed chronologically, allowing users to view both the category information and detailed schedule information for each schedule.

Method of Inputting Schedules through the Input Panel

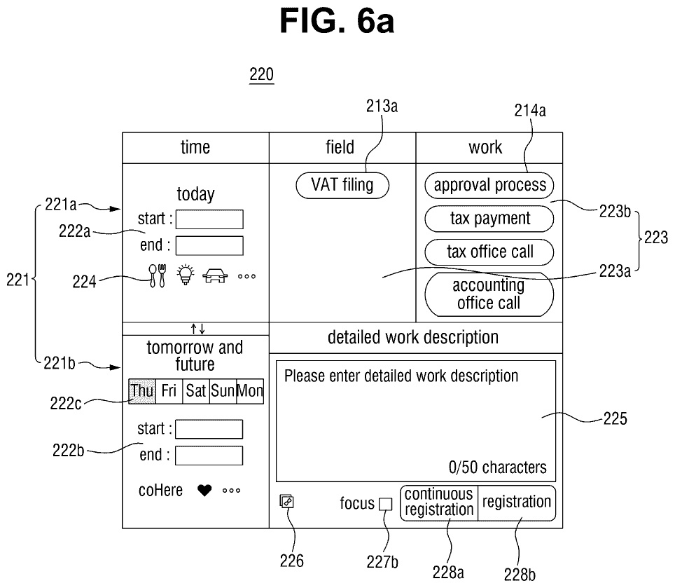

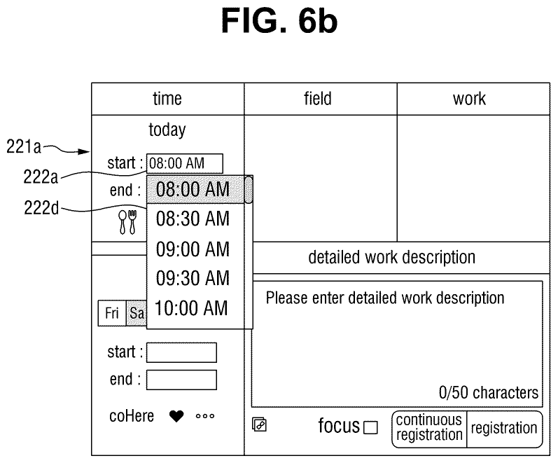

FIG. 6a is a diagram illustrating the input panel 220 according to an embodiment of the present disclosure.

Referring to FIG. 6a, the input panel 220 may include a time input section 221 for entering the time for a schedule; an item display section 223, which displays, for user's selection, item buttons for categories for the schedule already selected by the user through the category selection window 210 and/or one or more item buttons recommended for the categories by the calendar application, allowing the user to make selections; and a detailed description input section 225 for entering a detailed work description for the schedule.

In addition, the input panel 220 according to an embodiment of the present disclosure may include multiple quick buttons 224 that enable the user to promptly add repetitive or routine schedules, such as meals, recharging (rest), and move, as well as user-set schedules in the calendar application. Such quick buttons 224 may be displayed adjacent to the time input section 221, and each quick button 224 may include a thumbnail image that visually represents the content of the schedule. The user may intuitively and easily register repetitive schedules, such as meals and rest, without selecting a category by selecting a quick button 224. Details regarding quick buttons 224 will be described later.

In addition, the input panel 220 according to an embodiment of the present disclosure may include a link creation button 226 for adding an attachment or link related to the schedule; an external work button (not shown) for indicating that the schedule is an external schedule; a focus button 227b for indicating that the schedule requires concentration; a registration button 228b for registering the created schedule; and a continuous registration button 228a for registering temporally consecutive schedules.

Here, the continuous registration button 228a is a button that, when adding consecutively progressing schedules, sets the start time in the time input section 221 to the end time of the previously added schedule after adding a specific schedule, thereby enabling the user to promptly input schedules when registering consecutive schedules. That is, when the continuous registration button 228a is selected, the time range for a subsequent schedule is automatically filled after the registration of a specific schedule. The automatically filled time range for the subsequent schedule may correspond to the next time range of the specific schedule. For example, after registering a schedule with a time range of 9:00 AM-9:30 AM, if the user selects the continuous registration button 228a, a schedule item with the time range of 9:00 AM-9:30 AM is registered/created, while the time input section 221 is automatically filled with the time range of 9:30 AM-10:00 AM, allowing the user to conveniently input the subsequent schedule.

The time input section 221 of the input panel 220 according to an embodiment may include a first time input section 221a and a second time input section 221b. The first time input section 221a is for inputting schedules within the first time range, for example, today's schedules, and may include a first time input box 222a that allows the user to input the start time and end time for today's schedule. Additionally, the second time input section 221b is for inputting schedules within the second time range, which follows the first time range, for example, schedules for tomorrow and the future, and it may be positioned below the first time input section 221a. The second time input section 221b may include a second time input box 222b that allows the user to input the start time and end time for the schedules of each date (day of the week) within the second time range. Additionally, the second time input section 221b may include a day-of-the-week selection section 222c that displays the dates for tomorrow and the following days as days of the week. As in the example of FIG. 4, if today is Wednesday, the five days displayed in the day-of-the-week selection section 222c may be Thursday (Thu), Friday (Fri), Saturday (Sat), Sunday (Sun), and Monday (Mon).

FIG. 6b is an exemplary diagram illustrating a method for entering time through the time input section 221 according to an embodiment of the present disclosure.

Referring to FIG. 6b, the first time input box 222a of the time input section 221 may include a start time box and an end time box. When the user clicks/touches or hovers over the start time box of the first time input box 222a, a scrollable drop-down box 222d displaying time in 30-minute intervals may be presented. The user may then select any one of the 30-minute intervals from the drop-down box 222d. When a time is selected for the start time box, the end time box may automatically be populated with a time that is 30 minutes after the time entered in the start time box. If the user wants to change the time in the end time box, they may click/touch or hover over the end time box and select the desired time through the drop-down box. Input for the second time input box 222b may also be performed in the same manner.

Dividing time into 30-minute intervals in this way is intended to improve work efficiency by encouraging users to perform works divided into 30-minute time intervals, rather than having users directly input specific times. However, depending on the implementation of the calendar application, time may be presented in 1-hour intervals, 15-minute intervals, or other time units rather than 30-minute time intervals. Additionally, variations such as combining the drop-down box with a method that allows users to directly input times are also possible, and these implementations are not limited thereto.

According to another embodiment, the time input section 221 of the input panel 220 may be implemented through a single time input section instead of being configured with two time input sections, as in the example of FIG. 6. In this case, a single time input section may include both a time input box and a day-of-the-week selection section. However, the specific form of the input panel is not limited.

Referring again to FIG. 6a, the item display section 223 of the input panel 220 may display item buttons for categories for the schedules already selected by the user through the category selection window 210 and/or one or more item buttons recommended for the categories by the calendar application for user selection. The item display section 223 may include a first item display section 223a and a second item display section 223b. More specifically, the first item display section 223a may display one or more item buttons selected by the user from the item buttons 213a of the third category 213 of the category selection window 210 shown in FIG. 2, or up to a predetermined number (e.g., up to 5) of item buttons recommended by the calendar application. Additionally, the second item display section 223b may display one or more item buttons selected by the user from the item buttons 214a of the fourth category 214 (a lower category of the third category) in the category selection window 210, or up to a predetermined number (e.g., up to 5) of recommended item buttons suggested by the calendar application.

In a non-limiting example, the recommendation of one or more item buttons in each of the first item display section 223a and the second item display section 223b may be based on the usage frequency of each item button. In another example, the calendar application may recommend item buttons by comprehensively considering factors such as the usage frequency, time, cycle, ongoing works, and projects of each item button within the categories through an artificial neural network module. Various modifications may be made to the method of recommending item buttons for specific categories, and it is not limited thereto.

### Method for Adding Other Users and Attachments Related to a Schedule

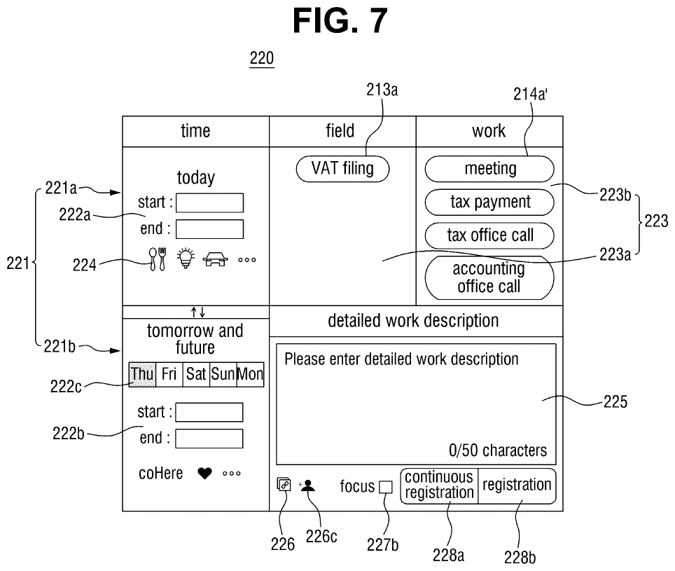

FIG. 7 is a diagram illustrating an example of adding other users related to a schedule through the input panel according to an embodiment of the present disclosure.

Referring to FIG. 7, when an item button 214a′ corresponding to a schedule requiring communication with other users, such as a “meeting,” is selected from among the item buttons of the fourth category 214, a counterpart addition icon 226c (e.g., a person-shaped icon) for adding information of other users may be added to a certain area of the input panel 220. When the counterpart addition icon 226c is dynamically added in this manner, the user of the calendar application may be guided to focus on the counterpart addition icon 226c and add other users through the icon. However, according to another example, the counterpart addition icon 226c may be constantly displayed on the input panel 220, and it is not limited thereto.

When the user selects the counterpart addition icon 226c, a separate user interface (e.g., a pop-up window) may be displayed, allowing the user to add other users related to the schedule, such as a “meeting,” for example, users who have attended or are scheduled to attend the meeting. In this user interface, other users from within or outside the institution to which the user belongs may be displayed. Through this user interface, the user may select and add other users related to the meeting, and the added other users may be visibly displayed for confirmation through the schedule boxes 231a and 231b of the timeline 230 or the schedule items 241 of the schedule display table 240.

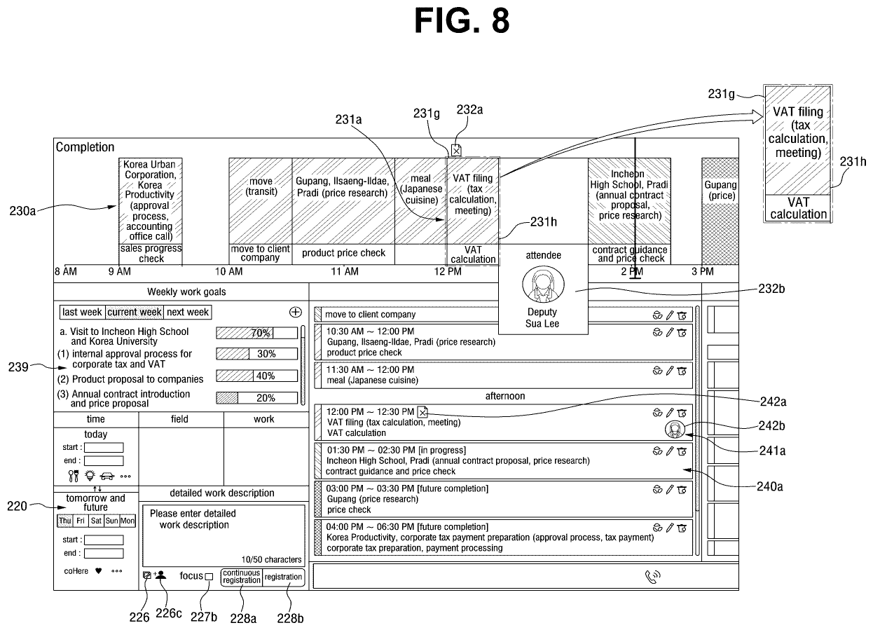

FIG. 8 is a diagram illustrating a user interface in which counterparts for a schedule and attached files have been added according to an embodiment of the present disclosure.

Referring to FIG. 8, when the user selects the counterpart addition icon 226c through the input panel 220 of the calendar application and selects and adds other users associated with the schedule via the user interface, the addition of these users may be displayed through the schedule boxes 231a or 231b on the timeline 230 and the schedule items 241a or 241b in the schedule display table 240.

Specifically, when the user selects the counterpart addition icon 226c and selects and adds other users associated with the schedule, a first identifier 231h, indicating the presence of other users associated with the schedule, may be generated in the schedule box 231a or 231b on the timeline 230. For example, the first identifier 231h may be generated in the bottom-right corner of the first area (colored area) of the schedule box 231a. Furthermore, when the user interacts with the schedule box 231a (e.g., by hovering the mouse cursor, mouse clicking, or touching), a first popup window 232b may be displayed adjacent to the schedule box 231a. This first popup window 232b may display information such as the photos and names of other users associated with the schedule, allowing the user to confirm these other users.

Additionally, when the user selects the counterpart addition icon 226c and selects and adds other users associated with the schedule, the photos 242b of the other users associated with the schedule may be displayed in the schedule items 241a or 241b in the schedule display table 240. The photos 242b of these other users may be displayed in the bottom-right area of the schedule item 241a, but the display position is not limited thereto.

Additionally, when the user selects the link creation button 226 through the input panel 220 of the calendar application, a separate user interface may be displayed, allowing the user to select and add attachments or links. When the user adds attachments or links associated with a schedule, a second identifier 231g, indicating the presence of attachments or links associated with the schedule, may be generated in the schedule box 231a or 231b on the timeline 230. The second identifier 231g may, for example, be generated in the top-left corner of the first area (colored area) of the schedule box 231a. Additionally, when the user interacts with the schedule box 231a or the second identifier 231g (e.g., by hovering the mouse cursor, mouse clicking, or touching), a second popup window 232a may be displayed adjacent to the schedule box 231a. This second popup window 232a may display an identifier (e.g., an icon representing the type of attachment) for the attachment or link associated with the schedule.

Additionally, when the user selects the link creation button 226 through the input panel 220 of the calendar application to add attachments or links associated with a schedule, an identifier 242a for the attachment or link associated with the schedule may be displayed in the schedule items 241a or 241b in the schedule display table 240. This identifier 242a for the attachment or link may be displayed to the right of the time range display of the schedule item 241a, but its display position is not limited thereto.

In this way, the user may easily add other users or attachments associated with a schedule through the counterpart addition icon 226c and the link creation button 226 in the input panel. Additionally, the user may easily identify information about other users associated with each schedule and/or attachments through the user interface of the calendar application, thereby improving the user's work efficiency. Furthermore, when the categories of schedules, counterpart-related information, attachments, and other data entered by the user are set to be shared with the institution's administrators or other users within the department, such information may contribute to improving the overall work efficiency of the institution or department.

### Method of Inputting Schedules Using a Quick Button

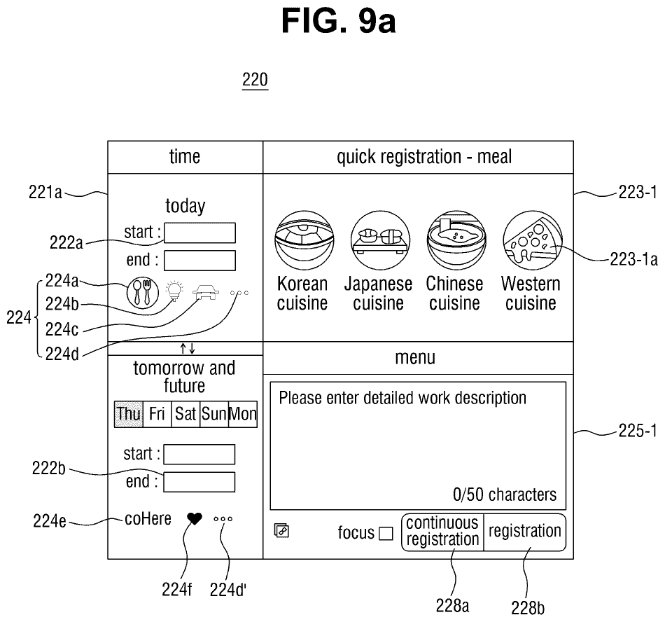

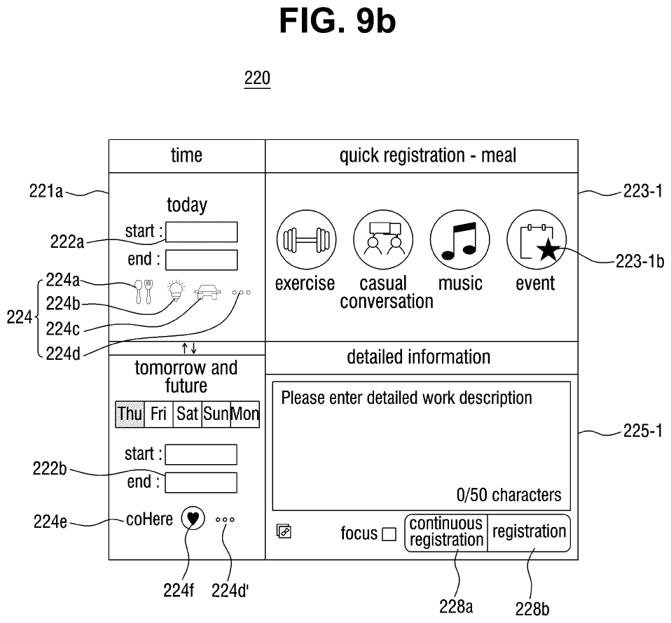

FIGS. 9a and 9b are diagrams illustrating exemplary usage methods of the quick buttons in the input panel of the user interface of the calendar application according to an embodiment of the present disclosure.

Referring to FIGS. 9a and 9b, in the input panel 220, the quick buttons 224 may be displayed adjacent to the time input section 221, and each quick button 224 may include a thumbnail image that visually represents the content of the schedule. By selecting a quick button 224, the user may promptly add at least one of routine and repetitive schedules, such as meals, rest, and move, i.e., “repetitive schedules,” and user-set schedules in the calendar application, i.e., “user-set schedules.” The method of inputting schedules using quick buttons may be performed intuitively and easily without the need for a separate category selection, unlike the categorized schedule input method described above in connection with FIGS. 6 and 7, which requires a category selection process before registration. In addition, since individuals may actively input schedules based on their own choices through visual images, it may enhance interest in the schedule input process.

The quick buttons 224 may include a first quick button 224a, a second quick button 224b, a third quick button 224c, and a first extended quick button 224d, which are located adjacent to and below the first time input box 222a of the first time input section 221a, as well as a fourth quick button 224e, a fifth quick button 224f, and a second extended quick button 224d′, which are located adjacent to and below the second time input section 222b. However, the number and arrangement of the quick buttons are not limited. Each of the first to fifth quick buttons may include a thumbnail image that visually represents the content of the schedule.

In the examples of FIGS. 9a and 9b, the first quick button 224a is a quick button related to meals and includes a thumbnail image associated with the “repetitive schedule” of meals (e.g., an image of a fork and spoon). The second quick button 224b is a quick button related to recharging (rest) and includes a thumbnail image associated with the “repetitive schedule” of rest (e.g., an image of a light bulb). The third quick button 224c is a quick button related to move (e.g., travel time during a business trip, worksite move time, etc.) and includes a thumbnail image associated with the “repetitive schedule” of move (e.g., an image of a car). The extended quick button 224d is a quick button for displaying the fourth quick button 224e and the fifth quick button 224f in the item display section 223-1 and may include an image such as “ . . . ” to indicate that expanded options are available through this quick button.

In addition, the fourth quick button 224e is a quick button related to a specific product (e.g., writing time spent by an individual on an application named “coHere”) and corresponds to a “user-set schedule” configured by the user of the calendar application. It includes a thumbnail image containing the name “coHere.” The fifth quick button 224f is a quick button related to entertainment and corresponds to a “user-set schedule” for entertainment elements configured by the user. It includes a thumbnail image associated with entertainment (e.g., an image of a heart). The second extended quick button 224d′ is a quick button for displaying the first quick button 224a, the second quick button 224b, and the third quick button 224c in the item display section 223-1 and may include an image such as “ . . . ” to indicate that expanded options are available through this quick button.

However, the functions, number, and thumbnail images of the quick buttons may be configured differently depending on the implementation of the calendar application, and they are not limited thereto. Such quick buttons may be preset by the administrator of the calendar application. However, the quick buttons may be configured to allow the user of the calendar application to edit them independently by adding, deleting, or modifying some quick buttons or editing the thumbnail images associated with the quick buttons.

Since the quick buttons are visually displayed in the form of thumbnail images in the user interface, the user may easily perform schedule input for repetitive schedules or user-set schedules. In particular, it may also encourage the input of schedules that are not directly related to work. In addition, the introduction of various quick buttons may broaden the range of choices for the user in deciding what schedule to perform during their free time throughout the day.

The example of FIG. 9a illustrates a case where the first quick button 224a related to meals is selected among the quick buttons 224. The first quick button 224a may include a thumbnail image of a spoon and fork representing a meal. When the first quick button 224a related to meals is selected, the first quick button 224a may be highlighted (e.g., colored and surrounded by a circle), and the item display section 223-1 of the input panel 220 may display detailed item buttons 223-1a corresponding to the first quick button 224a. For instance, buttons for Korean cuisine, Japanese cuisine, Chinese cuisine, and Western cuisine may be displayed. Each detailed item button 223-1a may include a thumbnail image associated with the content of the detailed item. For example, the Korean cuisine button may include a thumbnail image of bibimbap, the Japanese cuisine button may include a thumbnail image of sushi, the Chinese cuisine button may include a thumbnail image of jajangmyeon, and the Western cuisine button may include a thumbnail image of pizza. Additionally, the name of the item display section 223-1 may be changed to a name corresponding to the first quick button, such as “Quick Registration-Meal,” and the name of the detailed description input section 225-1 may also be changed to “Menu” to encourage the user to add descriptions related to meals.

Subsequently, the user may intuitively and easily register their repetitive and routine schedule related to meals by inputting a time in the time input section 222a of the input panel, selecting the first quick button 244a related to meals, selecting the Korean cuisine button, and then selecting the registration button 228b. However, in another example, the user may register a schedule by selecting only the time and a quick button without selecting a detailed item button.

In the aforementioned example, similar to the quick buttons described above, the functions, number, and thumbnail images of the detailed item buttons 223-1a may be configured differently depending on the implementation of the calendar application, and they are not limited thereto. In addition, such detailed item buttons may be preset by the administrator of the calendar application or configured to allow the user of the calendar application to independently edit them by adding, deleting, or modifying some detailed item buttons, or by editing the thumbnail images associated with the detailed item buttons. The introduction of various detailed item buttons related to quick buttons may broaden the range of choices for the user in determining specific schedules to perform. For example, if the user selects a quick button related to recharging, they may initially think only of “walking.” However, when detailed item buttons such as swimming, driving, or listening to music are displayed, the user may also consider scheduling these detailed activities.

The example of FIG. 9b illustrates a case where the fifth quick button 224f related to entertainment is selected among the quick buttons 224. The fifth quick button 224f may include a thumbnail image of a heart representing entertainment. When the fifth quick button 224f related to entertainment is selected, the fifth quick button 224f may be highlighted (e.g., colored and surrounded by a circle), and the item display section 223-1 may display detailed item buttons 223-1b corresponding to the fifth quick button 224f. For instance, buttons for exercise, casual conversation, music, and events may be displayed. Each detailed item button 223-1b may include a thumbnail image associated with the content of the detailed item. For example, the exercise button may include a thumbnail image of a dumbbell, the casual conversation button may include a thumbnail image representing two people having a conversation, the music button may include a thumbnail image of a musical note, and the event button may include a thumbnail image of a notebook with an overlapping star. Additionally, the name of the item display section 223-1 may also be changed to a name corresponding to the fifth quick button, such as “Quick Registration-Entertainment.”

Subsequently, the user may intuitively and easily register their routine schedule related to entertainment by inputting a time in the time input section 222a of the input panel, selecting the fifth quick button 224f related to entertainment, selecting the event button, entering detailed information in the description field if necessary, and then selecting the registration button 228b. However, in another example, the user may register a schedule by selecting only the time and a quick button without selecting a detailed item button.

The introduction of such quick buttons 224 is one of the various factors that allow the calendar application according to the present disclosure to have a clear distinction from existing calendar applications. In existing calendar applications, the process of adding schedules is cumbersome, making it very rare for users to continuously add repetitive or routine schedules. In contrast, the calendar application according to the present disclosure has a remarkable effect in that, by introducing quick buttons 224, which include thumbnails that visually represent the content of schedules, the user may promptly add repetitive or routine schedules or several user-set schedules through a simple and intuitive selection process of two to three steps, without the need for a separate category input process.

Furthermore, the introduction of such quick buttons 224 becomes a critical factor that enables users to continuously (or substantially without gaps) create their daily schedules (i.e., timeline). This is because entering repetitive schedules and schedules other than work-related ones is often considered cumbersome or easily overlooked, and the use of thumbnail images makes adding such schedules more engaging and convenient. When the user's daily schedules are continuously created and such schedule data accumulates, it has significant meaning in that the accumulated schedule data may enable the provision of a recommendation function (or an automatic recommendation function) for the entire or partial daily schedule of the user.

From another perspective, in the example of inputting a meal-related schedule using the quick buttons described above, the user may enter the type of menu they consumed through the quick button and detailed item buttons. Accordingly, when such meal-related schedule data is collected over a certain period, it may be utilized as data for identifying the user's dietary preferences. Through this, additional features may be configured, such as rearranging the order of detailed item buttons based on the user's dietary preferences, presenting recommended menu items for specific meal schedules, or even enabling automatic ordering when necessary by linking with other applications. In this way, the schedule input method using quick buttons enables the collection of a wider variety of schedule data, allowing the configuration of additional functions utilizing this data.

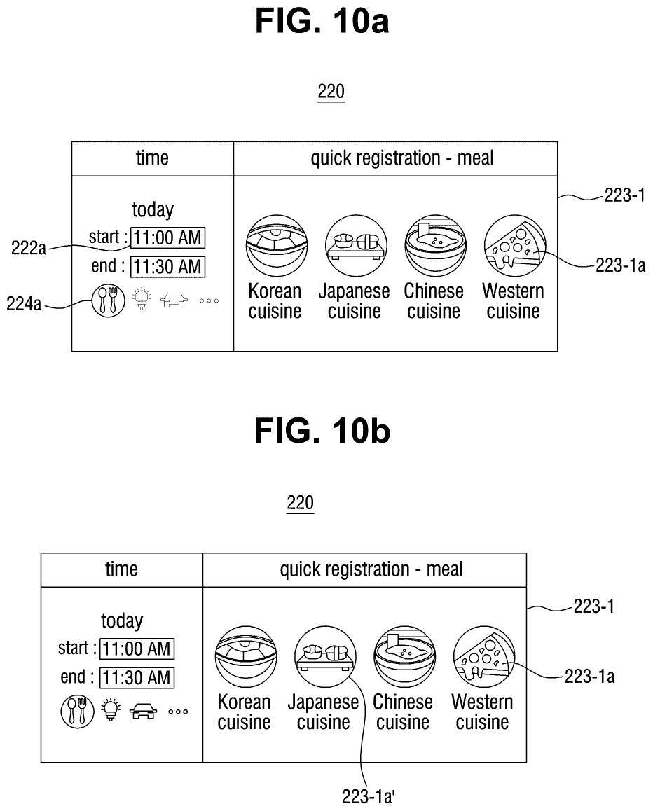

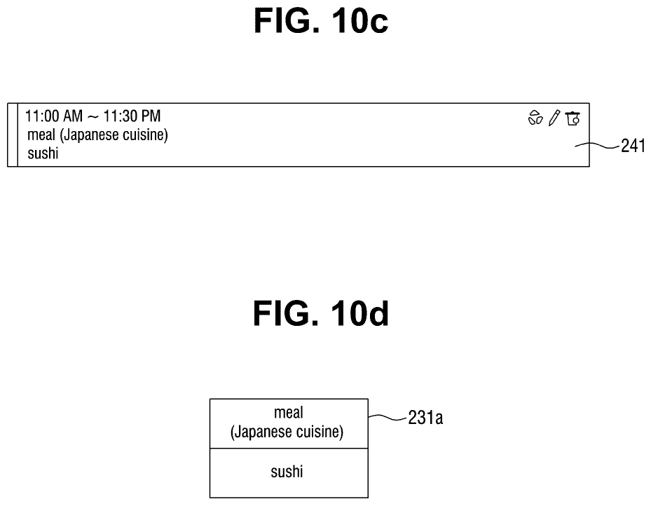

FIGS. 10a, 10b, 10c, and 10d are diagrams illustrating a method of creating a schedule using quick buttons according to an embodiment of the present disclosure.

Referring to FIG. 10a, the user may input a time in the time input section 222a of the input panel and select the first quick button 244a related to meals. Meanwhile, the order of time input and quick button selection may be interchangeable. When the first quick button 244a related to meals is selected, the item display section 223-1 may display detailed item buttons 223-1a corresponding to the first quick button 244a. For instance, buttons for Korean cuisine, Japanese cuisine, Chinese cuisine, and Western cuisine may be displayed. As described above, the quick buttons and detailed item buttons may each include a thumbnail image that is visually associated with the schedule content.

Referring to FIG. 10b, the user may select one detailed item button 223-1a′ from among the detailed item buttons 223-1a displayed in the item display section 223-1, for example, the Japanese cuisine button. Then, the user may optionally enter a specific menu name, such as “sushi,” in the detailed schedule display section 225-1 and register the schedule using the quick button by selecting the registration button 228b (or the continuous registration button 228a). However, in another example, the user may register a schedule by selecting only the time and a quick button without selecting a detailed item button.

Referring to FIG. 10c, a schedule item 241 in the schedule display table 240 corresponding to the registered meal schedule may be generated through the aforementioned process. Referring to FIG. 10d, a schedule box 230b in the timeline 230 corresponding to the registered meal schedule may be generated through the aforementioned process. At this time, each of the schedule item 241 and the schedule box 230b may include the entry “Meal (Japanese cuisine)” and the entry “Sushi.” In other words, in the case of a schedule input using a quick button in the above example, compared to a schedule input through a general method (i.e., the method described in connection with FIGS. 6 and 7), the name of the selected quick button may correspond to the third category, the name of the detailed item button may correspond to the fourth category, and the content entered in the detailed information section may correspond to the detailed work description.

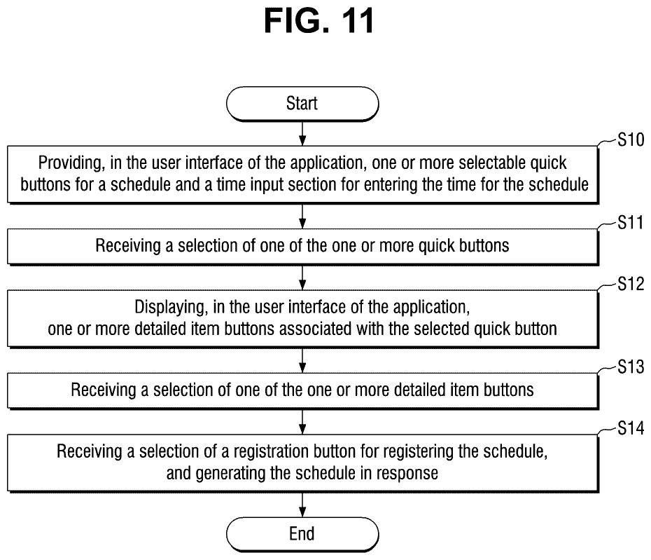

FIG. 11 is a flowchart illustrating a method of inputting a schedule using quick buttons according to an embodiment of the present disclosure.

Referring to FIG. 11, in step S10, the user interface of the application may provide one or more selectable quick buttons for a schedule and a time input section for entering the time for the schedule.

According to an embodiment, the user interface may include an input panel for entering schedules, and one or more quick buttons and a time input section may be provided on the input panel. At this time, the time input section of the input panel may include a first time input section for entering the time for a first time range and a second time input section for entering the time for a second time range following the first time range. Some of the one or more quick buttons may be displayed adjacent to the first time input section, while the remaining quick buttons may be displayed adjacent to the second time input section. However, the positions of the quick buttons and the time input section are not limited thereto and may vary depending on the implementation of the user interface.

According to an embodiment, one or more quick buttons are designed to create repetitive or routine schedules (i.e., repetitive schedules), such as meals, recharging (rest), move, and entertainment, and/or schedules set by the user (i.e., user-set schedules) with only a few intuitive and simple inputs, without the need for a separate category input.

In step S11, a selection of one of the one or more quick buttons may be received. Then, in response to receiving the selection of one of the one or more quick buttons, the names of each component of the input panel in the user interface (e.g., the item display section, the detailed schedule display section, etc.) may be changed and displayed accordingly. For example, when a quick button related to meals is selected, the name of the item display section may be changed to “Quick Registration-Meal,” and the name of the detailed schedule display section may be changed to “Menu.”

In step S12, one or more detailed item buttons associated with the selected quick button may be displayed in the user interface of the application. For example, if the selected quick button is related to meals, one or more detailed item buttons associated with the selected quick button may include a Korean cuisine button, a Japanese cuisine button, a Chinese cuisine button, and a Western cuisine button. In addition, if the selected quick button is related to rest (recharging), one or more detailed item buttons associated with the selected quick button may include a beverage button, a snack button, a walking button, and a nap and meditation button.

According to an embodiment, one or more detailed item buttons may be displayed in the item display section included in the input panel of the user interface.

In addition, as described above, the time input section of the input panel may include a first time input section and a second time input section. Some of the one or more quick buttons may be displayed adjacent to the first time input section, while the remaining quick buttons may be displayed adjacent to the second time input section. Among the one or more quick buttons displayed adjacent to the first time input section, some may include an extended quick button. When a selection of the extended quick button is received, one or more quick buttons displayed adjacent to the second time input section may be displayed in the item display section in response. In addition, the remaining of the one or more quick buttons displayed adjacent to the second time input section may include a second extended quick button. When a selection of the second extended quick button is received, one or more quick buttons displayed adjacent to the first time input section may be displayed in the item display section in response.

However, the display position, method, and thumbnail images of the detailed item buttons are not limited thereto and may vary depending on the implementation of the user interface.

In step S13, a selection of one of the one or more detailed item buttons may be received. In addition, input related to detailed information about the schedule may also be received through the detailed schedule input section.

In step S14, a selection of a registration button for registering the schedule may be received. In response to the selection of the registration button, a schedule item may be generated in at least one of the timeline and the schedule display table of the user interface.

Alternatively, in step S14, a selection of a continuous registration button for registering schedules consecutively may be received. In response to the selection of the continuous registration button, a schedule item may be generated in at least one of the timeline and the schedule display table of the user interface. In this case, the time range for the subsequent schedule may be automatically filled in the time input section of the input panel. The automatically filled time range for the subsequent schedule may correspond to the next time range of the registered schedule.

The introduction of such quick buttons provides a remarkable effect in that the calendar application according to the present disclosure enables the user to promptly add repetitive or routine schedules (i.e., repetitive schedules) and/or schedules set by the user (i.e., user-set schedules) through a simple and intuitive selection process of two to three steps, without the need for category input. Furthermore, the introduction of such quick buttons serves as a key point that enables the user to continuously (or substantially without gaps) create their daily schedule. This is because entering repetitive schedules or schedules other than work-related ones may be considered cumbersome or easily overlooked, and the use of thumbnail images makes adding such schedules more engaging and convenient. When the user's daily schedules are continuously created and such schedule data accumulates, it has significant meaning in that the accumulated schedule data may enable the provision of a recommendation function (or an automatic recommendation function) for the entire or partial daily schedule of the user.

### Computer-Readable Recording Medium

The fact that each step or operation of the method according to the embodiments of the present disclosure may be performed by a computer including one or more processors by executing a computer program stored in a computer-readable recording medium is apparent.

The computer-executable instructions stored in the aforementioned recording medium may be implemented through a computer program programmed to perform the corresponding steps, and such a computer program may be stored in a computer-readable recording medium and executed by a processor. The computer-readable recording medium may be a non-transitory readable medium. At this time, the non-transitory readable medium refers to a medium that does not store data for a brief moment, such as registers, cache, or memory, but rather stores data in a semi-permanent manner and is readable by a device. Specifically, programs for performing the various methods described above may be stored in and provided via non-transitory readable media, such as semiconductor memory devices including erasable programmable read-only memory (EPROM), electrically erasable programmable read-only memory (EEPROM), and flash memory devices; magnetic disks such as internal hard disks and removable disks; magneto-optical disks; and non-volatile memory including CD-ROM and DVD-ROM disks.

The methods according to various examples disclosed in this document may be provided as part of a computer program product. The computer program product may be distributed in the form of a machine-readable storage medium (e.g., compact disc read-only memory (CD-ROM)) or may be distributed online through an application store (e.g., Play Store™). In the case of online distribution, at least a portion of the computer program product may be at least temporarily stored in a storage medium such as the memory of a manufacturer's server, an application store server, or an intermediary server, or may be temporarily generated.

As described above, those skilled in the art to which the present disclosure pertains will understand that the present disclosure may be embodied in various specific forms without departing from the technical spirit or essential characteristics thereof. Therefore, the above-described embodiments should be understood as illustrative in all respects and not as limiting. The scope of the present disclosure is defined by the claims set forth below rather than by the detailed description, and all modifications or variations derived from the meaning, scope, and equivalent concepts of the claims should be interpreted as being included within the scope of the present disclosure.

The features and advantages described herein do not encompass all possible features and advantages, and in particular, numerous additional features and advantages will become apparent to those skilled in the art upon consideration of the drawings, the specification, and the claims. Furthermore, it should be noted that the language used in the present specification has been primarily selected for readability and instructional purposes and may not have been chosen to describe or limit the subject matter of the present disclosure.

The foregoing description of the embodiments of the present disclosure has been provided for illustrative purposes. This is not intended to limit the present disclosure to the exact form disclosed or to be made without omission. Those skilled in the art will appreciate that numerous modifications and variations are possible in light of the above disclosure.

Accordingly, the scope of the present disclosure is not limited by the detailed description but is defined by any claims of the application based thereon. Thus, the disclosure of the embodiments of the present disclosure is exemplary and does not limit the scope of the present disclosure as set forth in the following claims.

1. A method of inputting a schedule using quick buttons, comprising:
providing, in a user interface of an application, a time input section for entering a time for a schedule;
providing, in the user interface, one or more selectable quick buttons for the schedule, wherein each of the one or more quick buttons includes a thumbnail that visually represents the content of the schedule, and the schedule includes at least one of a repetitive schedule and a user-set schedule;
receiving a selection of one of the one or more quick buttons and an input of the time for the schedule;
displaying, in the user interface, one or more selectable detailed item buttons associated with the schedule of the selected quick button, wherein each of the one or more detailed item buttons includes a thumbnail that visually represents the content of the detailed item; and
receiving a selection of one of the one or more detailed item buttons.

2. The method according to claim 1, wherein the schedule selectable through the quick button includes at least one of a schedule related to meals, a schedule related to rest, a schedule related to move, and a schedule related to entertainment.

3. The method according to claim 2, wherein, when a schedule related to meals is selected through the quick button, one or more detailed item buttons associated with the selected quick button include a plurality of meal type buttons.

4. The method according to claim 2, wherein, when a schedule related to rest is selected through the quick button, one or more detailed item buttons associated with the selected quick button include a plurality of rest type buttons.

5. The method according to claim 1, wherein the user interface includes an input panel, and
the one or more quick buttons and the time input section are provided on the input panel.

6. The method according to claim 1, wherein the user interface includes an input panel, and
the one or more detailed item buttons are displayed in an item display section included in the input panel.

7. The method according to claim 5, further comprising:
displaying a changed name of at least one component of the input panel in response to the receiving a selection of one of the one or more quick buttons.

8. The method according to claim 5, wherein the input panel includes a first time input section for entering a time for a first time range and a second time input section for entering a time for a second time range following the first time range, and
wherein some of the one or more quick buttons are displayed adjacent to the first time input section, and the remaining quick buttons of the one or more quick buttons are displayed adjacent to the second time input section.

9. The method according to claim 8, wherein the input panel further includes an item display section,
wherein some of the one or more quick buttons displayed adjacent to the first time input section include an extended quick button, and
wherein the method further comprises:
receiving a selection of the extended quick button; and
in response to the receiving the selection of the extended quick button, displaying the remaining quick buttons among the one or more quick buttons displayed adjacent to the second time input section in the item display section of the input panel.

10. The method according to claim 1, further comprising:
receiving a selection of a registration button for registering the schedule; and
in response to the selection of the registration button, generating a schedule item in at least one of a timeline and a schedule display table of the user interface.

11. The method according to claim 10, wherein the generated schedule item includes the name of the selected quick button.

12. An apparatus for implementing a schedule input method using quick buttons, the apparatus comprising:
a processor; and
a memory including computer-executable instructions, wherein the computer-executable instructions, when executed by the processor, cause the processor to perform operations including:
providing, in a user interface of an application, a time input section for entering a time for a schedule;
providing, in the user interface, one or more selectable quick buttons for the schedule, wherein each of the one or more quick buttons includes a thumbnail that visually represents the content of the corresponding schedule, and the corresponding schedule includes at least one of a repetitive schedule and a user-set schedule;
receiving a selection of one of the one or more quick buttons and an input of the time for the schedule;
displaying, in the user interface, one or more selectable detailed item buttons associated with the schedule of the selected quick button, wherein each of the one or more detailed item buttons includes a thumbnail that visually represents the content of the corresponding detailed item; and
receiving a selection of one of the one or more detailed item buttons.

13. A computer-readable recording medium storing computer-executable instructions,
wherein the computer-executable instructions, when executed by a processor, cause the processor to perform operations including:
providing, in a user interface of an application, a time input section for entering a time for a schedule;
providing, in the user interface, one or more selectable quick buttons for the schedule, wherein each of the one or more quick buttons includes a thumbnail that visually represents the content of the corresponding schedule, and the corresponding schedule includes at least one of a repetitive schedule and a user-set schedule;
receiving a selection of one of the one or more quick buttons and an input of the time for the schedule;
displaying, in the user interface, one or more selectable detailed item buttons associated with the schedule of the selected quick button, wherein each of the one or more detailed item buttons includes a thumbnail that visually represents the content of the corresponding detailed item; and
receiving a selection of one of the one or more detailed item buttons.
